(19) United States
(12) Patent Application Publication
(10) Pub. No.: US 2018/0115896 A1
(43) Pub. Date: Apr. 26, 2018

(54) SEAMLESS UNIQUE USER IDENTIFICATION AND MANAGEMENT

(71) Applicant: GOGO APP PTE. LTD., Singapore (SG)

(72) Inventors: Wing Hong CHOW, Singapore (SG); Weng Fei CHOW, Singapore (SG)

(21) Appl. No.: 15/567,080

(22) PCT Filed: May 19, 2016
(86) PCT No.: PCT/SG2016/050236

§ 371 Date: Oct. 17, 2017

(30) Foreign Application Priority Data
May 22, 2015 (SG) 10201504042U

(51) Int. Cl. H04W 12/06; G06F 21/62; G06F 8/61; H04L 29/06

(52) U.S. Cl. CPC H04W 12/06; G06F 21/629; H04L 63/0876; H04L 63/0428; G06F 8/61

(57) ABSTRACT

The invention discloses a method and apparatus for the automated capturing and management of Unique Identifiers in electronic and other equipment, so that one or more users can be uniquely identified and granted access to a service or services via one or more communication networks.

### CROSS-REFERENCE TO RELATED APPLICATIONS

This application is a national phase entry of PCT/SG2016/050236 filed on May 19, 2016 which claims priority to Singapore application 10201504042U filed on May 22, 2015, the disclosures of which are incorporated by reference herein.

### FIELD OF THE INVENTION

The invention relates generally to user authentication and management, and more specifically to a method and apparatus for the seamless and automated capturing and management of Unique Identifiers in electronic and other equipment, so that one or more users can be uniquely identified and granted access to a service or services via one or more communication networks.

### BACKGROUND

Mobile apps installed in smartphones allow their users to access a wide variety of services, ranging from e-banking and e-shopping to video streaming and mobile gaming.

Many of the above-stated services require a user to be uniquely identified and authenticated, before access to the service concerned is granted. Typically, user identification and authentication is performed by prompting the user to manually input personal details such as a user name and password. Given that the average user would often have multiple user names and passwords for different kinds of services (such as Facebook, Yahoo Mail, Gmail, Twitter, e-banking, Netflix, Amazon, or some other service), it is quite possible for the user to forget his/her user name and password for a particular service, resulting in increased inconvenience as the user may have to request for a new user name and/or password to be generated or for the existing user name and/or password to be sent to him/her. In addition, the manual input of details such as a user name and password on the user's smartphone can be tedious and prone to errors, given the absence of a proper text input device such as a physical QWERTY keyboard in many smartphones.

To address the above-stated problems, some solutions have been developed to reduce the need for manual input of personal details such as a user name and password on the part of the user, but these solutions are often limited. For example, PCT Application WO2007/091012 discloses a registration process which automatically gathers and stores information about a user and the equipment used by the user (such as a smartphone) when subscribing to a service. The stored information is used for user authentication during subsequent service requests by the user. Although the subsequent service requests do not require the user to manually input any information, the user is still required to enter some information manually when making the initial request to subscribe to the service. In addition, the disclosure in PCT Application WO2007/091012 does not provide a method for managing and updating the stored information, in situations where the user changes the Subscriber Identity Module card (more commonly known as “SIM card”) and/or the smartphone.

In light of the above, there is a need for an invention which can seamlessly and automatically capture and manage information about a user and the equipment used by the user, so that the user can be uniquely identified and granted access to a service via a communication network, even when the user changes the SIM card (or some other variant of the SIM card such as NanoSIM or MicroSIM) and/or the equipment concerned.

### SUMMARY OF THE INVENTION

The present invention overcomes the limitations of the prior art by disclosing a method for the seamless and automated capturing and management of Unique Identifiers in electronic and other equipment, for the purpose of uniquely identifying one or more users and granting these users access to a service or services via one or more communication networks.

According to one aspect of the present invention, there is provided a method of granting a client terminal access to a service in communication with a server terminal, the method comprising:
initiating an application, installed in the client terminal, that is configured to access the service;
transmitting, using the installed application, data about the client terminal to the server terminal, the data comprising one or more Unique Identifiers, wherein one of the Unique Identifiers, if present, is a Unique Subscriber Identity assigned by the server terminal to the installed application;
processing, at the server terminal, the data received about the client terminal against one or more stored Unique Identifiers;
updating the one or more stored Unique Identifiers, that are different from the received one or more Unique Identifiers, with the received one or more Unique Identifiers, when there is a match between at least one of the one or more stored Unique Identifiers and the received one or more Unique Identifiers;
transmitting, from the server terminal to the client terminal, the Unique Subscriber Identity, after the Unique Subscriber Identity is generated in response to its absence in the data received about the client terminal;

transmitting, from the server terminal, the Unique Subscriber Identity to the service; and
granting the application installed in the client terminal access to the service in response to the service receiving the Unique Subscriber Identity.

Further details and advantages of the invention will become apparent from a consideration of the drawings and subsequent detailed description of the invention.

### BRIEF DESCRIPTION OF THE DRAWINGS

FIG. 1 illustrates an exemplary arrangement of devices suitable for implementing an embodiment of the present invention.

FIG. 2a illustrates the process flow which occurs when a user uses the SUUIM application installed on the client terminal to access a Service for the first time, in one embodiment of the present invention.

FIG. 2b illustrates the process flow which occurs when a user uses the SUUIM application installed on the client terminal to access a Service from the second time onwards, in one embodiment of the present invention.

FIG. 3 illustrates the verification process which occurs when a user has changed his/her client terminal and/or SIM card, in one embodiment of the present invention.

FIG. 4 illustrates the process flow which occurs when a user voluntarily enters his/her MSISDN for added security and convenience, in one embodiment of the present invention.

FIG. 5a illustrates the process flow which occurs when a user's MSISDN (and optionally, <UI-CT>) is pre-authorized in the server terminal's list of Unique Identifiers by an administrator terminal, and the user uses the SUUIM application installed on the client terminal to access a Service for the first time, in one embodiment of the present invention.

FIG. 5b illustrates the process flow which occurs when a user's MSISDN (and optionally, <UI-CT>) is pre-authorized in the server terminal's list of Unique Identifiers by an administrator terminal, and the user uses the SUUIM application installed on the client terminal to access a Service from the second time onwards, in one embodiment of the present invention.

FIG. 6 illustrates the process flow which occurs in a secured door access system incorporating the SUUIM features, in one embodiment of the present invention.

### DETAILED DESCRIPTION OF THE INVENTION

The present invention is described herein with reference to particular embodiments. The invention is not, however, limited to such embodiments.

In embodiments of the present invention, there is disclosed a Seamless Unique User Identification and Management (“SUUIM”) process which captures and manages one or more Unique Identifiers present in electronic and other equipment, so that one or more users can be uniquely identified and granted access to a Service via one or more communication networks.

The Service stated above includes (but is not limited to) the following: an application in the cloud; an application in a private local network; a hardware device; a video-streaming service; a mobile-gaming service; and any kind of service, application, or device.

The Unique Identifiers stated above include (but are not limited to) the following:

IMSI: International Mobile Subscriber Identity—a 15 decimal digit unique code embedded in the SIM card (or some variant of the SIM card such as MicroSIM or NanoSIM) which connects to a mobile network.
MSISDN: Mobile Station International Subscriber Directory Number—an identifier uniquely identifying a subscription in a mobile network; i.e. the mobile number to the SIM card (or some variant of the SIM card) in a mobile phone.
IMEI: International Mobile Station Equipment Identity—a 15 or 16 decimal digit unique code embedded in the chipset of a mobile device.
MAC: Media Access Control address—a Unique Identifier assigned to network interfaces for communications on the physical network segment. MAC addresses are used as a network address for most IEEE 802 network technologies, including Ethernet and WiFi.
UUID: Universally Unique Identifier—an identifier standard used in software construction. A UUID is a unique 128-bit value where each bit is defined by any of several variants.

One or more of the Unique Identifiers stated above (such as UUID) can be used to generate another Unique Identifier known as a Unique Subscriber Identity <UserID>, which is in turn used for the purposes of uniquely identifying a user and granting the user access to the Service.

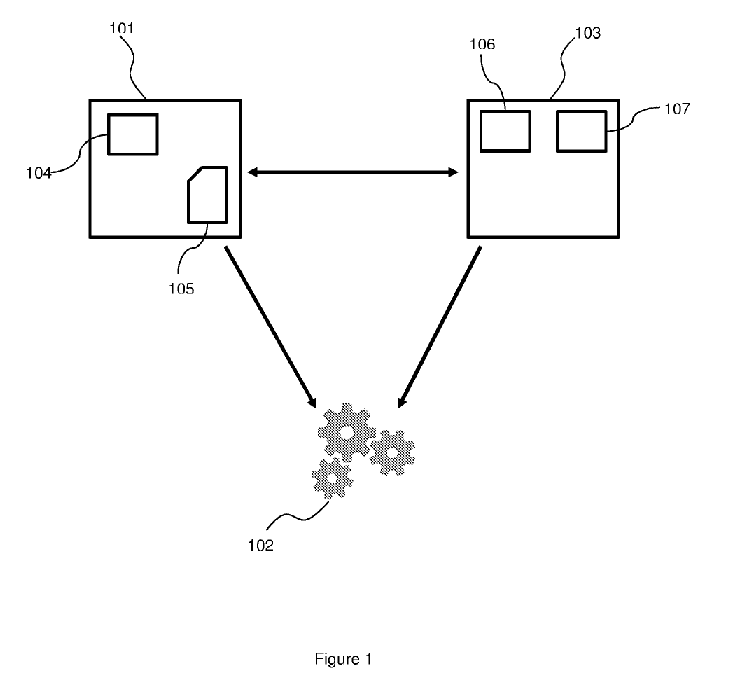

FIG. 1 illustrates an arrangement of devices suitable for implementing an embodiment of the invention. The arrangement comprises a client terminal 101 (such as a mobile phone), a Service 102 (such as a video-streaming service), and a server terminal 103 (such as a computer server), which are communicatively coupled to one another by a network (such as GSM, UMTS, LTE, or other network). In addition, the server terminal 103 and Service 102 are also communicatively coupled to each other using a suitable wireline or wireless network (such as Ethernet, WLAN, GSM, or other network).

The client terminal 101 includes a data store 104 which can be used to store data such as photos, phone numbers, videos, and applications. The Unique Identifiers IMEI and MAC are associated with the hardware component of the client terminal, while the Unique Identifier UUID is associated with the software component of the client terminal. The client terminal 101 may also contain a Subscriber Identity Module card (more commonly known as “SIM card”) 105, or some other variant of the SIM card such as a NanoSIM or MicroSIM. The Unique Identifiers IMSI and MSISDN are also associated with the SIM card 105. Hereinafter, the term <UI-CT> is used to refer to the Unique Identifier(s) associated with the client terminal, comprising any one or more of IMEI, MAC, and UUID, while the term <UI-SIM> is used to refer to the Unique Identifier(s) associated with the SIM card, comprising any one or more of IMSI and MSISDN.

The server terminal 103 includes a data store 106 which can be used to store applications as well as information associated with one or more users, such as the Unique Identifiers. The server terminal 103 may also contain a short message service (“SMS”) and/or instant messaging (“IM”) gateway 107 for sending and receiving messages to or from the client terminal.

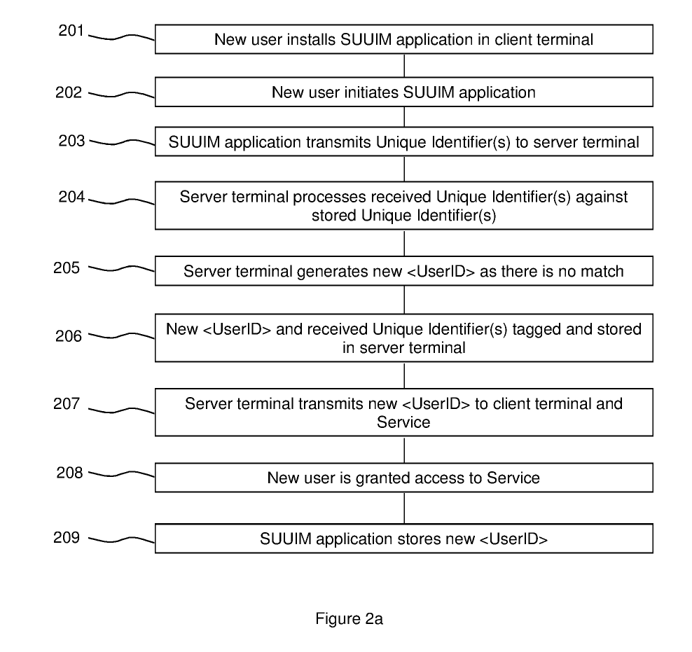

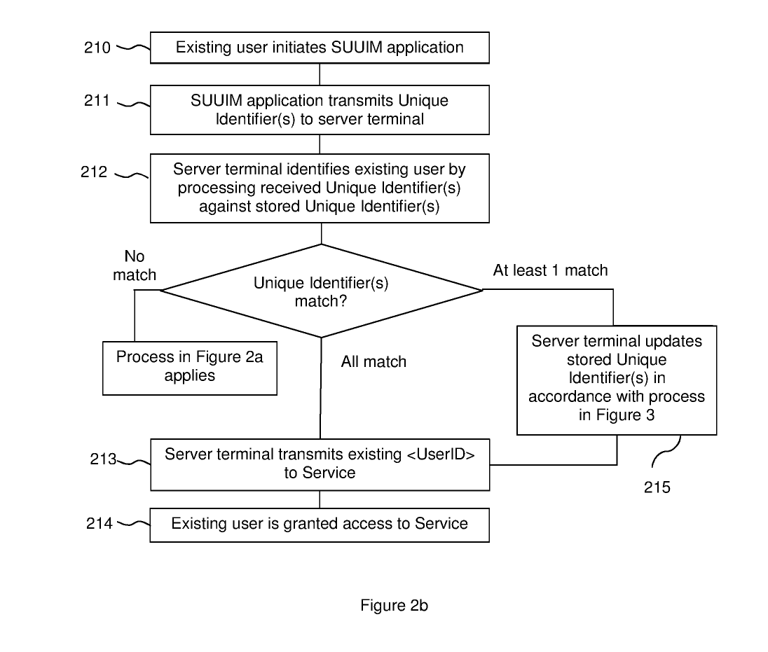

FIG. 2a illustrates an embodiment of the invention when a new user accesses a Service for the first time. A new user who wishes to access a Service (102 in FIG. 1) for the first time will have to install 201 in the client terminal (101 in FIG. 1) an application incorporating the SUUIM features (i.e. “SUUIM application”). When the user initiates 202 the SUUIM application, the SUUIM application will transmit 203 one or more of the Unique Identifiers (such as IMEI, MAC, UUID, or IMSI) from the client terminal to the server terminal (103 in FIG. 1).

After receiving these one or more Unique Identifiers, the server terminal will process 204 these received Unique Identifiers against the list of Unique Identifiers stored in the server terminal. Finding no match between any of the received Unique Identifiers and any of the stored Unique Identifiers, the server terminal will generate 205 a new Unique Identifier known as the Unique Subscriber Identity <UserID> based on one or more of the received Unique Identifiers (such as UUID). The server terminal will tag the received Unique Identifiers with the new <UserID> and store this information 206 in its list of Unique Identifiers. The server terminal will also transmit 207 the new <UserID> to both the client terminal and Service, following which the user is granted access 208 to the Service. The SUUIM application will also store 209 the new <UserID> that was transmitted from the server terminal.

FIG. 2b continues from FIG. 2a by depicting the same embodiment when an existing user accesses a Service from the second time onwards. When the existing user initiates 210 the SUUIM application installed in the client terminal, the SUUIM application will transmit 211 one or more of the Unique Identifiers (such as IMEI, MAC, UUID, or IMSI) from the client terminal to the server terminal. In addition, if the Unique Identifier <UserID> exists in the client terminal, the SUUIM application will also transmit <UserID> from the client terminal to the server terminal. After receiving these one or more Unique Identifiers, the server terminal will process 212 these received Unique Identifiers against the list of Unique Identifiers stored in the server terminal. If all the received Unique Identifiers match the stored Unique Identifiers, the server terminal will transmit 213 the existing <UserID> to the Service, following which the user is granted access 214 to the Service.

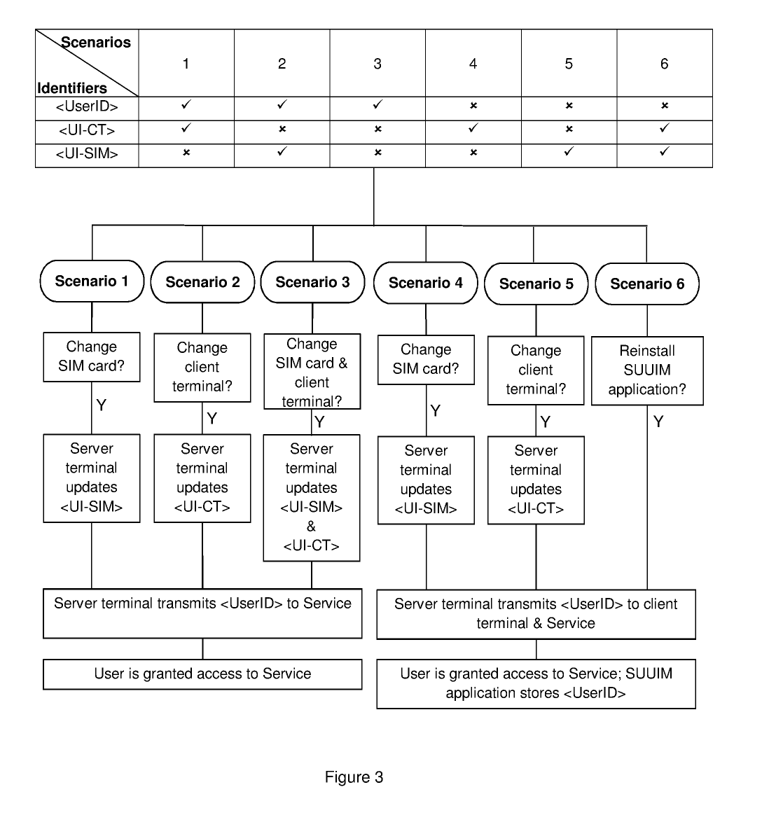

If there is a match between at least one (but not all) of the stored Unique Identifiers and at least one (but not all) of the received Unique Identifiers, the server terminal will update 215 the stored Unique Identifier(s) which are different from the corresponding received Unique Identifier(s), with the corresponding received Unique Identifier(s), in accordance with the verification process described in FIG. 3. Subsequently, the server terminal will transmit 213 the existing <UserID> to the Service, following which the user is granted access 214 to the Service.

In the event that none of the received Unique Identifiers match any of the stored Unique Identifiers (for example, in the case of a new user rather than an existing user), the process described earlier in FIG. 2a will apply.

FIG. 3 describes the verification process in one embodiment of the invention, covering the 6 different scenarios which may occur when the existing user changes his/her client terminal and/or SIM card. In the matrix depicted in FIG. 3 (and as mentioned earlier), the term <UI-CT> refers to the Unique Identifier(s) associated with the client terminal, comprising any one or more of IMEI, MAC, and UUID, while the term <UI-SIM> refers to the Unique Identifier(s) associated with the SIM card, comprising any one or more of IMSI and MSISDN. The “✓” in the matrix indicates that there is a match between the received Unique Identifier and corresponding stored Unique Identifier, while the “x” in the matrix indicates that there is no match between the received Unique Identifier and corresponding stored Unique Identifier.

In scenario 1, the user has only changed his/her SIM card. As such, there will be a match between the <UserID> and <UI-CT> received from the client terminal, and the corresponding <UserID> and <UI-CT> stored in the server terminal. However, there will not be a match between the received <UI-SIM> and corresponding stored <UI-SIM>.

In scenario 2, the user has only changed his/her client terminal. After changing the client terminal, the user has restored the SUUIM application (with the existing settings and data) from the previous client terminal in the new client terminal, for example by using a backup from the cloud or a physical backup stored on a computer. As such, there will be a match between the <UserID> and <UI-SIM> received from the client terminal, and the corresponding <UserID> and <UI-SIM> stored in the server terminal. However, there will not be a match between the received <UI-CT> and corresponding stored <UI-CT>.

In scenario 3, the user has changed both his/her SIM card and his/her client terminal. However, the user has restored the SUUIM application (with the existing settings and data) from the previous client terminal in the new client terminal, for example by using a backup from the cloud or a physical backup stored on a computer. As such, there will be a match between the <UserID> received from the client terminal and the corresponding <UserID> stored in the server terminal, but no match between the received <UI-SIM> and <UI-CT> and corresponding stored <UI-SIM> and <UI-CT>.

In scenario 4, the user has only changed his/her SIM card. However, for some reason, the user may have uninstalled the old SUUIM application, and then installed a new SUUIM application in the client terminal instead of restoring it from a backup. As such, there will be a match between the <UI-CT> received from the client terminal, and the corresponding <UI-CT> stored in the server terminal. However, there will not be a match between the received <UI-SIM> and corresponding stored <UI-SIM>. In addition, no <UserID> will be transmitted by the new SUUIM application installed in the client terminal.

In scenario 5, the user has only changed his/her client terminal. After changing the client terminal, the user has installed a new SUUIM application in the client terminal instead of restoring the SUUIM application from a backup. As such, there will be a match between the <UI-SIM> received from the client terminal, and the corresponding <UI-SIM> stored in the server terminal. However, there will not be a match between the received <UI-CT> and corresponding stored <UI-CT>. In addition, no <UserID> will be transmitted by the new SUUIM application installed in the client terminal.

In scenario 6, the user did not change his/her client terminal and SIM card. However, for some reason, the user may have uninstalled the old SUUIM application, and then installed a new SUUIM application in the client terminal instead of restoring it from a backup. As such, there will be a match between the <UI-CT> and <UI-SIM> received from the client terminal, and the corresponding <UI-CT> and <UI-SIM> stored in the server terminal. However, no <UserID> will be transmitted by the new SUUIM application installed in the client terminal.

Depending on the applicable scenario as illustrated in FIG. 3, the server terminal will send an instant message or SMS to the SUUIM application installed in the client terminal, asking one or more of the following questions:

a) Did you change your mobile device?
b) Did you change your SIM card?
c) Did you change both your mobile device and SIM card?
d) Did you re-install the application?

The user will be prompted to answer “Y” or “N” for the above questions. Based on these answers, the server terminal will update the stored Unique Identifier(s) which are different from the corresponding received Unique Identifier(s), with the corresponding received Unique Identifier(s), as illustrated in scenarios 1 to 6 of FIG. 3.

Subsequently, for scenarios 1, 2, and 3, the server terminal will transmit <UserID> to the Service, following which the user is granted access to the Service. For scenarios 4, 5 and 6, the server terminal will transmit <UserID> to both the client terminal and Service, following which the user is also granted access to the Service. For scenarios 4, 5, and 6, the SUUIM application in the client terminal will further store the <UserID> that was transmitted from the server terminal.

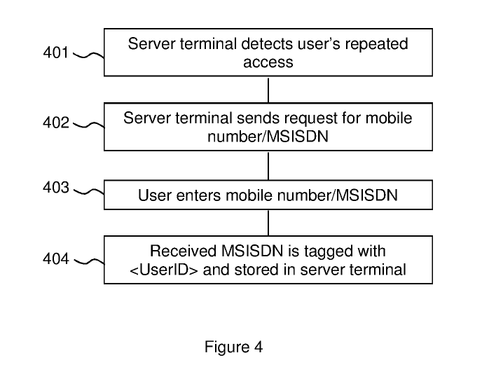

FIG. 4 illustrates another embodiment of the invention where a loyal user may optionally enter his/her mobile number (i.e. MSISDN) for added security and convenience. In this embodiment, when the server terminal detects 401 that the Service has been accessed after a predetermined number of times, the server terminal will send 402 an instant message or SMS to the SUUIM application installed in the client terminal, asking the user to enter his/her mobile number on a voluntary basis. If the user chooses to provide his/her mobile number/MSISDN 403, the received MSISDN will be tagged with the user's <UserID> and stored 404 in the server terminal's list of Unique Identifiers.

Subsequently, if a change in one or more of the received Unique Identifiers is detected, the user will be prompted to enter his/her MSISDN (via SMS or instant message). If the received MSISDN matches the corresponding MSISDN stored in the server terminal, the server terminal will update the stored Unique Identifier(s) which are different from the corresponding received Unique Identifier(s), with the corresponding received Unique Identifier(s).

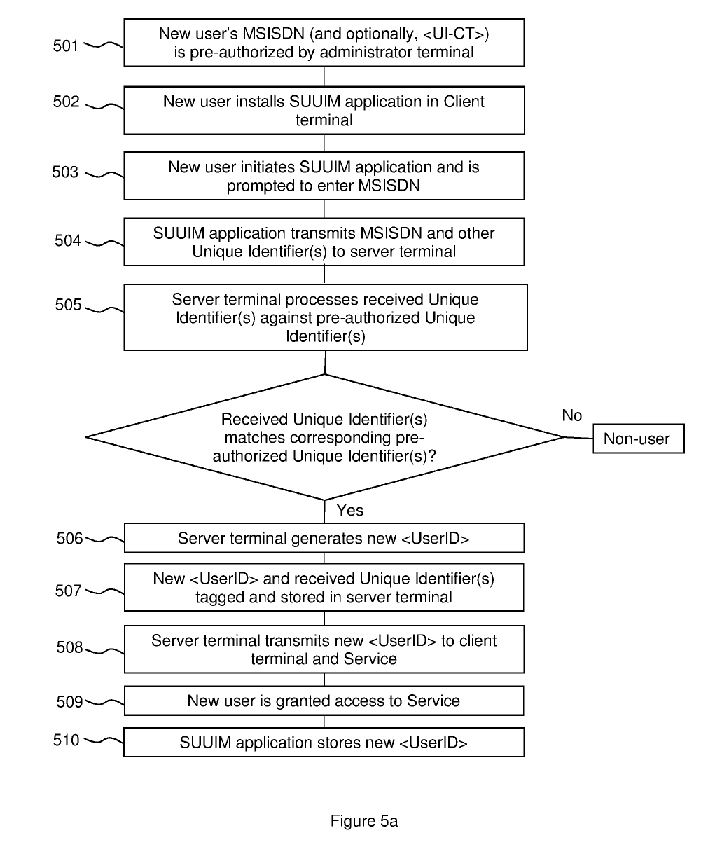

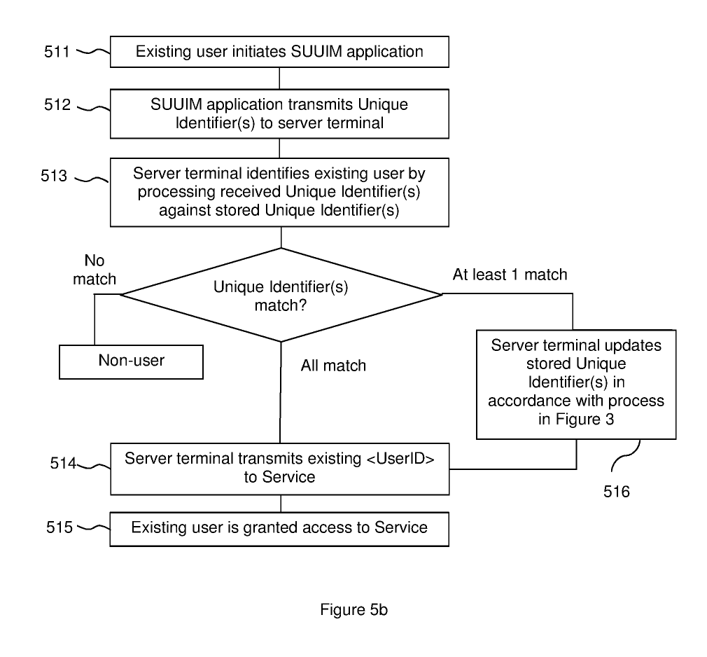

FIG. 5a illustrates one embodiment of the invention when an administrator terminal pre-authorizes 501 a new user's MSISDN in the server terminal's list of Unique Identifiers, and the new user accesses a Service for the first time. In addition to pre-authorizing the user's MSISDN, the administrator terminal may optionally pre-authorize the user's <UI-CT> (comprising one or more of IMEI, MAC, and UUID) in the server terminal's list of Unique Identifiers as well. In this embodiment, a new user who wishes to access a Service for the first time will have to install 502 the SUUIM application in the client terminal. When the SUUIM application is initiated 503 by the user, the SUUIM application will prompt the user to enter his/her MSISDN, before transmitting 504 the user's MSISDN and one or more of the other Unique Identifiers (such as IMSI, IMEI, MAC, or UUID) from the client terminal to the server terminal.

After receiving these one or more Unique Identifiers, the server terminal will process 505 these received Unique Identifiers against the pre-authorized list of Unique Identifiers stored in the server terminal. If there is a match between the received MSISDN and the corresponding pre-authorized MSISDN (if the <UI-CT> has been pre-authorized, there must also be a match between the received <UI-CT> and corresponding pre-authorized <UI-CT>), the server terminal will generate 506 a new Unique Identifier known as the Unique Subscriber Identity <UserID> based on one or more of the received Unique Identifiers (such as UUID). The server terminal will tag the received Unique Identifiers with the new <UserID> and store this information 507 in its list of Unique Identifiers. The server terminal will also transmit 508 <UserID> to both the client terminal and Service, following which the user is granted access 509 to the Service. The SUUIM application will also store 510 the new <UserID> that was transmitted from the server terminal.

FIG. 5b continues from FIG. 5a by depicting the same embodiment when an existing user accesses a Service from the second time onwards. When the existing user initiates 511 the SUUIM application installed in the client terminal, the SUUIM application will transmit 512 one or more of the Unique Identifiers (such as IMEI, MAC, UUID, or IMSI) from the client terminal to the server terminal. In addition, if the Unique Identifier <UserID> exists in the client terminal, the SUUIM application will also transmit <UserID> from the client terminal to the server terminal. After receiving these one or more Unique Identifiers, the server terminal will process 513 these received Unique Identifiers against the list of Unique Identifiers stored in the server terminal. If all the received Unique Identifiers match the stored Unique Identifiers, the server terminal will transmit 514 the existing <UserID> to the Service, following which the user is granted access 515 to the Service.

If there is a match between at least one (but not all) of the stored Unique Identifiers and at least one (but not all) of the received Unique Identifiers, the server terminal will update 516 the stored Unique Identifier(s) which are different from the corresponding received Unique Identifier(s), with the corresponding received Unique Identifier(s), in accordance with the verification process described in FIG. 3. Subsequently, the server terminal will transmit 514 the existing <UserID> to the Service, following which the user is granted access 515 to the Service.

In the event that none of the received Unique Identifiers match any of the stored Unique Identifiers (for example, in the case of an unauthorized user), access to the Service will not be granted.

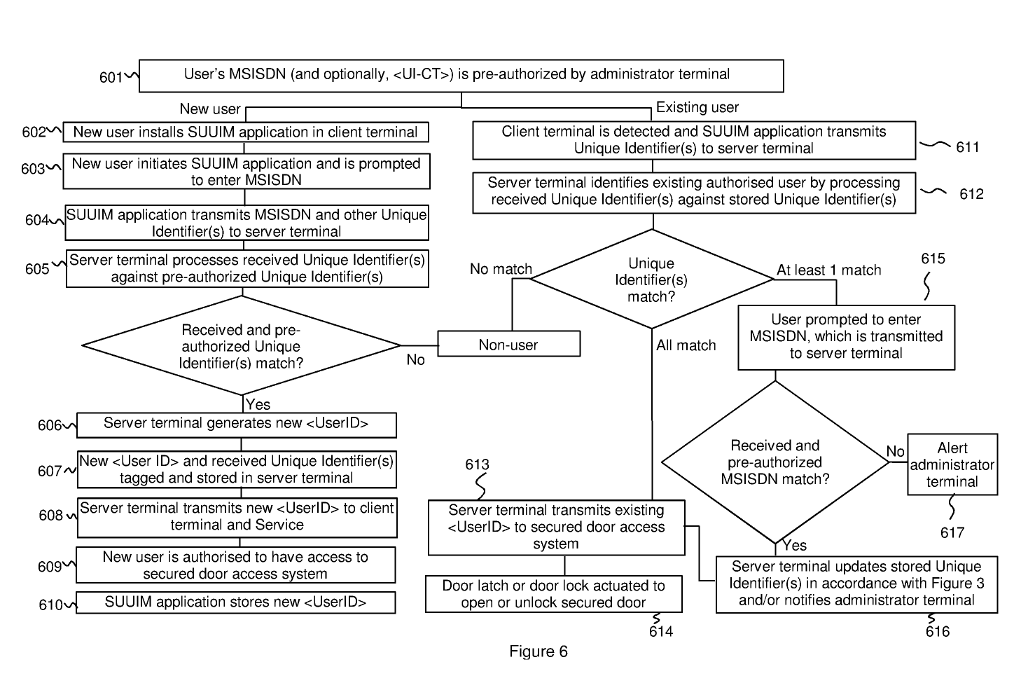

FIG. 6 illustrates yet another embodiment of the invention, where the Service in question is a secured door access system, and a communication sensor is incorporated in a door latch or door lock to open or unlock the secured door when an authorized user is detected. The communication sensor can be operated by technologies which include (but are not limited to) Bluetooth, Wifi, Near-Field Communication (“NFC”), or Radio-Frequency Identification (“RFID”).

In this particular embodiment, a user's MSISDN is pre-authorized 601 in the server terminal's list of Unique Identifiers by an administrator terminal. In addition to pre-authorizing the user's MSISDN, the administrator terminal may optionally pre-authorize the user's <UI-CT> (comprising one or more of IMEI, MAC, and UUID) as well. A new user who wishes to gain access to the secured door access system for the first time will have to install 602 the SUUIM application in the client terminal. When the SUUIM application is initiated 603 by the user, the SUUIM application will prompt the user to enter his/her MSISDN, before transmitting 604 the user's MSISDN and one or more of the Unique Identifiers (such as IMSI, IMEI, MAC, or UUID) from the client terminal to the server terminal.

After receiving these one or more Unique Identifiers, the server terminal will process 605 these received Unique Identifiers against the pre-authorized list of Unique Identifiers stored in the server terminal. If there is a match between the received MSISDN and the corresponding pre-authorized MSISDN (if the <UI-CT> has been pre-authorized, there must also be a match between the received <UI-CT> and corresponding pre-authorized <UI-CT>), the server terminal will generate 606 a new Unique Identifier known as the Unique Subscriber Identity <UserID> based on one or more of the received Unique Identifiers (such as UUID). The server terminal will tag the received Unique Identifiers with the generated <UserID> and store this information 607 in its list of Unique Identifiers. The server terminal will also transmit 608 the new <UserID> to both the client terminal and Service, following which the user is now authorized to have access 609 to the secure door access system. The SUUIM application will also store 610 the <UserID> that was transmitted from the server terminal.

When an existing authorized user is near (for example, within 5 metres) the secured door of the secured door access system, the communication sensor in the secured door will detect the user's client terminal, and the SUUIM application installed in the client terminal will transmit 611 one or more of the Unique Identifiers (such as IMEI, MAC, UUID, or IMSI) from the client terminal to the server terminal. In addition, if the Unique Identifier <UserID> exists in the client terminal, the SUUIM application will also transmit <UserID> from the client terminal to the server terminal. After receiving these one or more Unique Identifiers, the server terminal will process 612 these received Unique Identifiers against the list of Unique Identifiers stored in the server terminal. If all the received Unique Identifiers match the stored Unique Identifiers, the server terminal will transmit 613 the existing <UserID> to the secured door access system, following which the door latch or door lock will be actuated 614 to open or unlock the secured door for the existing authorized user.

If there is a match between at least one (but not all) of the stored Unique Identifiers and at least one (but not all) of the received Unique Identifiers, the SUUIM application will prompt the user to enter his/her MSISDN and transmit the MSISDN 615 from the client terminal to the server terminal. If the MSISDN provided by the user matches the corresponding pre-authorized MSISDN stored in the server terminal, the server terminal will update the stored Unique Identifier(s) which are different from the corresponding received Unique Identifier(s), with the corresponding received Unique Identifier(s), in accordance with the verification process described in FIG. 3, and/or notify the administrator terminal 616. Subsequently, the server terminal will transmit <UserID> to the secured door access system 613, following which the door latch or door lock will be actuated 614 to open the door for the authorized user. However, in the event that the MSISDN provided by the user does not match the corresponding pre-authorized MSISDN stored in the server terminal, the administrator terminal may be alerted 617 and the secured door will remain locked.

In the event that none of the received Unique Identifiers match any of the stored Unique Identifiers (for example, in the case of an unauthorized user), the secured door will also remain locked.

In some embodiments of the invention (including the embodiments described earlier in FIGS. 5a, 5b and 6), the administrator terminal may, at any time, de-authorize any user by removing the user's <UserID> and corresponding Unique Identifiers from the list of Unique Identifiers stored in the server terminal.

In other embodiments of the invention (including the embodiments described earlier in FIGS. 1 through 6), when a user wishes to unsubscribe from a Service, he/she may do so via the unsubscribe function in the Service. Alternatively, the user may also unsubscribe from the Service by providing the <UserID> (or some other Unique Identifier) to the Service Provider, via email or some other means of communication (such as by telephone or an online customer service portal).

In various embodiments of the invention (including the embodiments described earlier in FIGS. 1 through 6), the information (including the Unique Identifiers) transmitted between the client terminal, server terminal, and Service may be encrypted to enhance communication security, via encryption and decryption algorithms embedded within the client terminal, server terminal, and/or Service.

Finally, there are several modifications or variations which may be made to one or more of the above-described embodiments without departing from the scope of the invention. Although these modifications or variations have not been described, a person skilled in the art will be able to recognize and/or make such modifications or variations.

1. A method of granting a client terminal access to a service in communication with a server terminal, the method comprising:
initiating an application, installed in the client terminal, that is configured to access the service;
transmitting, using the installed application, data about the client terminal to the server terminal, the data comprising one or more Unique Identifiers, wherein one of the Unique Identifiers, if present, is a Unique Subscriber Identity assigned by the server terminal to the installed application;
processing, at the server terminal, the data received about the client terminal against one or more stored Unique Identifiers;
prompting the client terminal when there is a match between at least one of the one or more stored Unique Identifiers and the received one or more Unique Identifiers, but not all of the received Unique Identifiers match with the stored Unique Identifiers;
updating the one or more stored Unique Identifiers, that are different from the received one or more Unique Identifiers, with the received one or more Unique Identifiers, in response to one or more answers received from the client terminal;
transmitting, from the server terminal to the client terminal, the Unique Subscriber Identity, after the Unique Subscriber Identity is generated in response to its absence in the data received about the client terminal;
transmitting, from the server terminal, the Unique Subscriber Identity to the service; and
granting the application installed in the client terminal access to the service in response to the service receiving the Unique Subscriber Identity.

2. The method according to claim 1, wherein the generation of the Unique Subscriber Identity at the server terminal is further in response to receipt of the data about the client terminal that is transmitted from the client terminal.

3. The method according to claim 1, wherein the transmission of the Unique Subscriber Identity is done without requiring the receipt of user credentials, the user credentials comprising any one or more of a login user name, a login password, a birthdate, an email address, or some other user detail.

4. The method according to claim 1, further comprising downloading the application in the client terminal; and installing the application.

5. The method according to claim 1, further comprising storing the received one or more Unique Identifiers as new data when all of the received one or more Unique Identifiers are different from the one or more stored Unique Identifiers.

6. The method according to claim 1, wherein the Unique Identifiers comprise any one or more of Unique Subscriber Identity, IMSI, IMEI, MAC, MSISDN, and UUID.

7. The method according to claim 1, wherein any one or more of IMSI, IMEI, MAC, MSISDN, and UUID is grouped with the Unique Subscriber Identity assigned to the installed application.

8. (canceled)

9. The method according to claim 1, wherein the one or more answers received from the client terminal comprise any one or more of letters, numerals, symbols, characters, or combination thereof.

10. The method according to claim 7, further comprising prompting the client terminal to provide the MSISDN of the client terminal after the server terminal detects that the service has been accessed after a predetermined number of times; and updating the one or more stored Unique Identifiers with the received MSISDN.

11. The method according to claim 10 further comprising:
prompting the client terminal when there is a match between at least one or more received Unique Identifiers and at least one or more stored Unique Identifiers, but not all of the received Unique Identifiers match with the stored Unique Identifiers; and
updating the one or more stored Unique Identifiers that have changed when the MSISDN received in response to the prompt matches the stored MSISDN.

12. The method according to claim 1, wherein the one or more stored Unique Identifiers is input from an administrator terminal and wherein the transmission of the generated Unique Subscriber Identity from the server terminal to the client terminal is in response to the received one or more Unique Identifiers matching a selected one or more of the stored Unique Identifiers.

13. The method according to claim 12, wherein the transmission of the Unique Subscriber Identity to the service is in response to the received one or more Unique Identifiers matching a selected one or more of the stored Unique Identifiers.

14. The method according to claim 12, further comprising:
prompting the client terminal when there is a match between at least one or more received Unique Identifiers and at least one or more stored Unique Identifiers, but not all of the received Unique Identifiers match with the stored Unique Identifiers; and
updating the one or more stored Unique Identifiers that have changed when the one or more Unique Identifiers, received in response to the prompting, matches the selected one or more of the stored Unique Identifiers; and
alerting the administrator terminal when the one or more Unique Identifiers, received in response to the prompting, is different from the selected one or more of the stored Unique Identifiers.

15. The method according to claim 14, wherein the selected one of the stored Unique Identifiers comprise any one or more of Unique Subscriber Identity, IMSI, IMEI, MAC, MSISDN, and UUID.

16. The method according to claim 1, wherein the received data about the client terminal is encrypted and wherein the method further comprises decrypting, at the server terminal, the encrypted received data.

17. The method according to claim 1, further comprising:
encrypting, at the server terminal, the generated Unique Subscriber Identity before transmission to the client terminal, and
decrypting, at the client terminal, the encrypted generated Unique Subscriber Identity, using the installed application.

18. The method according to claim 1, wherein the client terminal is a mobile phone, a tablet, a computing terminal, or electronic equipment.

19. The method according to claim 1, wherein the service is hosted in the server terminal that transmits the Unique Subscriber Identity to the client terminal, or a separate server terminal.

20. The method according to claim 1, wherein the service comprises any one or more of an application in the cloud, an application in a private local network, a hardware device, a video-streaming service, a mobile-gaming service, a secured door access system, or any kind of application, device, or service offering.

21. A server terminal configured to execute the method according to claim 1.

22. A server terminal for granting access to a service accessible by an application installed in a client terminal, the server terminal comprising:
at least one processor;
at least one memory including computer program code;
the at least one memory and the computer program code configured to, with the at least one processor, cause the server terminal at least to:
receive, from the installed application in the client terminal, data about the client terminal, the data comprising one or more Unique Identifiers, wherein one of the Unique Identifiers, if present, is a Unique Subscriber Identity assigned by the server terminal to the installed application;
process the data received about the client terminal against one or more stored Unique Identifiers;
prompt the client terminal when there is a match between at least one of the one or more stored Unique Identifiers and the received one or more Unique Identifiers, but not all of the received Unique Identifiers match with the stored Unique Identifiers;
update the one or more stored Unique Identifiers, that are different from the received one or more Unique Identifiers, with the received one or more Unique Identifiers, in response to one or more answers received from the client terminal;
transmit, from the server terminal to the client terminal, the Unique Subscriber Identity, after the Unique Subscriber Identity is generated in response to its absence in the data received about the client terminal; and
transmit, from the server terminal to the service, the Unique Subscriber Identity, wherein the installed application is granted access to the service in response to the service receiving the Unique Subscriber Identity.

23. (canceled)
